(19) United States
(12) Patent Application Publication
(10) Pub. No.: US 2010/0129777 A1
(43) Pub. Date: May 27, 2010

(54) KIT FOR FIXING A DENTAL RESTORATION MATERIAL ON A TOOTH SUBSTANCE

(75) Inventor: Silke Ziegler, Hamburg (DE)

Correspondence Address: Casimir Jones, S.C., 2275 DEMING WAY, SUITE 310, MIDDLETON, WI, 53562, US

(73) Assignee: ERNST MüHLBAUER GMBH & CO. KG, Norderfriedrichskoog (DE)

(21) Appl. No.: 12/531,618

(22) PCT Filed: Mar. 12, 2008
(86) PCT No.: PCT/EP08/01984

§ 371 Date: Feb. 2, 2010

(30) Foreign Application Priority Data
Mar. 16, 2007 (EP) 07005445.7

(51) Int. Cl. A61C 5/00; C08G 63/12

(52) U.S. Cl. 433/215; 525/450

(57) ABSTRACT

The subject matter of the invention is a kit for fixing a dental restoration material on a tooth substance, which material contains the following components: a. an electron donor compound; b. a first adhesive component which contains an oxidation agent as constituent of a polymerization initiator system and a polymerizable acid; c. a second adhesive component which contains a reduction agent as constituent of a polymerization initiator system and a polymerizable monomer, oligomer, or prepolymer, which does not contain any acid groups.

The invention relates to a kit for fixing a dental restoration material onto a tooth substance.

It is well known, in dentistry, to fix dental restoration materials, for example synthetic materials, such as composites, onto a tooth substance, in particular dentin, using dental adhesives. In this connection, the dentin is frequently etched with an acid before the application of the dental adhesive.

EP 0 767 652 B1 discloses a method mentioned at the start in which, before the application of the dental adhesive, first etching with an acid is carried out and then a primer is applied.

It is an object of the invention to produce a kit of the type mentioned at the start which, on simple use, brings about good coupling between tooth substance and dental restoration material.

A kit according to the invention exhibits the following components:
a. an electron-donating compound;
b. a first adhesive component which comprises an oxidizing agent as constituent of a polymerization initiator system and a polymerizable acid;
c. a second adhesive component which comprises a reducing agent as constituent of a polymerization initiator system and a polymerizable monomer, oligomer or prepolymer not comprising acid groups.

The kit according to the invention accordingly comprises at least three components. The first component comprises an electron-donating compound. The electron-donating compound has an E_{OX}>0 V and preferably of approximately from 0.5 to 1 V, in comparison with a saturated calomel electrode (SCE) as reference. Preferred electron-donating compounds are suitable aromatic organic acids or salts of these acids, such as, for example, an aromatic sulfinic acid or the salt thereof or barbituric acid or a barbituric acid derivative. Suitable sulfinic acid salts are, for example, the alkali metal salts, alkaline earth metal salts, amine salts or ammonium salts. The alkali metal salts can in particular be lithium, sodium or potassium salts. Among the alkaline earth metal salts, magnesium, calcium, strontium and barium salts are preferred. The amine salts can be primary amine salts exhibiting, for example, the following groups: methylamine, ethylamine, propylamine, butylamine, aniline, toluidine, phenylenediamine or xylylenediamine. Secondary amine salts can exhibit the following groups: dimethylamine, diethylamine, dipropylamine, dibutylamine, piperidine, N-methylaniline, N-ethylaniline, diphenylamine or N-methyltoluidine. Tertiary amines can exhibit the following groups: trimethylamine, triethylamine, pyridine, N,N-dimethylaniline, N,N-di(β-hydroxyethyl)aniline, N,N-diethylamine, N,N-dimethyltoluidine, N,N-diethyltoluidine or N,N-(β-hydroxyethyl)toluidine. Use may be made, as ammonium salts, for example, of tetramethylammonium salts, tetraethylammonium salts, tetrapropylammonium salts or trimethylbenzylammonium salts.

Suitable organic sulfinic acids are alkanesulfinic acids (for example, ethanesulfinic acid, propanesulfinic acid, hexanesulfinic acid, octanesulfinic acid, decanesulfinic acid and dodecanesulfinic acid); alicyclic sulfinic acids, such as cyclohexanesulfinic acid and cyclooctanesulfinic acid; and also aromatic sulfinic acids, such as benzenesulfinic acid, o-toluenesulfinic acid, p-toluenesulfinic acid, ethylbenzenesulfinic acid, decylbenzenesulfinic acid, dodecylbenzenesulfinic acid, chlorobenzenesulfinic acid and naphthalenesulfinic acid.

Suitable organic sulfinic acid salts are, for example, benzenesulfinic acid salts with the following counterions: sodium, potassium, magnesium, calcium, strontium, barium, butylamine, aniline, toluidine, phenylenediamine, diethylamine, diphenylamine, triethylamine, ammonium, tetramethylammonium and trimethylbenzylammonium. Suitable counterions for o-toluenesulfinic acid salts are, for example, lithium, sodium, potassium, calcium, cyclohexylamine, aniline, ammonium and tetraethylammonium. Suitable counterions for p-toluenesulfinic acid salts are, for example, lithium, sodium, potassium, calcium, barium, ethylamine, toluidine, N-methylaniline, pyridine, ammonium and tetramethylammonium. Suitable counterions for β-naphthalenesulfinic acid salts are, for example, sodium, strontium, triethylamine, N-methyltoluidine, ammonium, trimethylbenzylammonium and the like.

Suitable barbituric acids are, for example, 1,3,5-trimethylbarbituric acid, 1,3,5-triethylbarbituric acid, 1,3-dimethyl-5-ethylbarbituric acid, 1,5-dimethylbarbituric acid, 1-methyl-5-ethylbarbituric acid, 1-methyl-5-propylbarbituric acid, 5-ethylbarbituric acid, 5-propylbarbituric acid, 5-butylbarbituric acid, 5-methyl-l-butylbarbituric acid, 1-benzyl-5-phenylbarbituric acid, 1-cyclohexyl-5-ethylbarbituric acid or alkali metal salts of the abovementioned acids.

Particularly preferred aromatic sulfinate salts are sodium benzenesulfinate and sodium toluenesulfinate.

The first and second adhesive components each comprise an oxidizing agent or reducing agent as constituent of a polymerization initiator system. Such a redox catalyst system produces free radicals by interaction of reducing agent and oxidizing agent, which free radicals are able to initiate the polymerization of ethylenically unsaturated polymerizable constituents.

Suitable oxidizing agents are, for example, persulfates and preferably organic peroxides. Mention may be made, by way of example, of diacetyl peroxide, dipropyl peroxide, dibutyl peroxide, dicapryl peroxide, dilauryl peroxide, dibenzoyl peroxide (BPO), p,p′-dichlorobenzoyl peroxide, p,p′-dimethoxybenzoyl peroxide, p,p′-dimethylbenzoyl peroxide and p,p′-dinitrodibenzoyl peroxide.

Use may be made, as reducing agents of the polymerization initiator system, in particular of aliphatic, alicyclic or aromatic amines. Use may be made of primary, secondary or tertiary amines. Preference is given to aromatic amines, in particular tertiary aromatic amines. Among tertiary aromatic amines, N,N-bis(2-hydroxyethyl)-p-toluidine, N,N-di-methyl-p-tert-butylaniline, N,N-diethylaminobenzoic acid (DEABA) and 4-(dimethylamino)phenethyl alcohol are particularly preferred.

The first adhesive component comprises a polymerizable acid. “Polymerizable” means in this connection that this acid comprises ethylenically unsaturated double bonds via which, triggered by the polymerization initiator system, a polymerization or crosslinking can take place. The acid functional groups of the polymerizable acid serve in particular for the firm bonding with the tooth substance, in particular with dentin or enamel. Suitable polymerizable acids are, for example, polymerizable homopolymers or copolymers of an α,β-unsaturated carboxylic acid. Mention may be made, by way of example, of (meth)acrylated polyacrylic acids, or copolymers of the acid mentioned, on the one hand, and, for example, maleic acid and/or itaconic acid, on the other hand. Preferably, the polymerizable acid exhibits a mean molar mass of 2000 to 100 000, preferably of 5000 to 60 000, more preferably of 10 000 to 50 000, more preferably of 20 000 to 40 000.

The second adhesive component exhibits a polymerizable monomer, oligomer or prepolymer not comprising acid groups. In this connection, a monomer with at least one ethylenically unsaturated group, for example an acrylate or methacrylate, or a monomer, oligomer or prepolymer with a vinyl group may be involved. Particular preference is given to monomers with acrylate or methacrylate groups. Mention may be made, by way of example, of hydroxyethyl(meth)acrylate, hydroxypropyl(meth)acrylate, hydroxybutyl(meth)acrylate, glycerol di(meth)acrylate, glycerol mono(meth)acrylate, methyl(meth)acrylate, ethyl(meth)acrylate, propyl(meth)acrylate, butyl(meth)acrylate, hexyl(meth)acrylate, octyl(meth)acrylate, lauryl(meth)acrylate, decyl(meth)acrylate, tridecyl(meth)acrylate, 2-ethoxyethyl(meth)acrylate, 2′-ethoxy-2-ethoxyethyl(meth)acrylate, ethylene glycol di(meth)acrylate, diethylene glycol di(meth)acrylate, triethylene glycol di(meth)acrylate (TEGDMA), tetraethylene glycol di(meth)acrylate, polyethylene glycol mono(meth)acrylate, polyethylene glycol di(meth)acrylate, polypropylene glycol mono(meth)acrylate, polypropylene glycol di(meth)acrylate, polytetramethylene glycol mono(meth)acrylate, polytetramethylene glycol di(meth)acrylate, hexanediol di(meth)acrylate, trimethylolpropane tri(meth)acrylate, UDMA (reaction product of 2-hydroxyethyl methacrylate (HEMA) with 2,4,4-trimethylhexane diisocyanate), 2,2-bis[4-(2-hydroxy-3-methacryloyloxypropoxy)phenyl]propane (Bis-GMA), ethoxylated bisphenol A dimethacrylate and the like. Hydroxyethyl methacrylate (HEMA) is particularly preferred as polymerizable monomer without acid groups.

The kit according to the invention is employed as follows:

The tooth substance to be treated is first prepared in a conventional fashion. A preparation may first be carried out with instruments such as, for example, a drill. Subsequently, the surface is rinsed and dried.

In the next stage, the tooth surface to be treated is etched with acid. Suitable acids can be inorganic or organic acids; they preferably exhibit a pKa in water which is smaller than or equal to the pKa value of phenol. Preferred pKa values lie between −20 and ₊10, more preferably between −10 and +5. Suitable inorganic acids are, for example, hydrochloric acid, nitric acid and hydrobromic acid. Suitable organic acids are, for example, formic acid, trifluoroacetic acid, trichloroacetic acid, dichloroacetic acid, chloroacetic acid, bromoacetic acid, di- and tribromoacetic acid, acetic acid, α-chloropropionic acid, propionic acid, maleic acid, fumaric acid, acrylic acid, methacrylic acid, trihydroxybenzoic acid, benzoic acid, toluenesulfonic acid, phenol and suitable phenol derivatives, phosphoric acid, suitable phosphite esters and the like. Preference is given to acids which, in the etching operation, do not produce any insoluble calcium salts on the surface of the tooth substance which might interfere with the adherence of the dental restoration material to be applied thereto. If such salts are formed, these can, if appropriate, be rinsed off after the etching stage.

After the etching, the electron-donating compound is applied. In the context of the kits according to the invention, this electron-donating compound is preferably present in a physiologically acceptable solvent. Suitable solvents are, for example, water, acetone, alkyl alcohols, such as ethanol or propanol, or the like. It is preferable for the physiologically acceptable solvent to be readily volatile at body temperature, such as, for example, alcohol. “Physiologically acceptable” means, in the context of the invention, that the solvent, when normally applied, has no or only insignificant disadvantageous effects on the organism.

The electron-donating compound is preferably dissolved in the solvent in a proportion of 0.1 to 20% by weight, more preferably of 0.5 to 15% by weight, more preferably of 1 to 10% by weight. It can be applied using suitable applicators (sponge, brush or the like); subsequently, the solvent is preferably allowed to evaporate.

In the next stage, a mixture of the first and second adhesive components is applied. This mixture is preferably prepared only immediately before the application on the treated tooth substance. The mixture can be prepared manually, for example by stirring with a thin brush. The mixture is preferably prepared using an applicator, as will be described in more detail below.

This mixture is applied as dental adhesive to the tooth substance. The redox catalyst system initiates a polymerization and at last curing of the adhesive. In the context of the invention, it is possible to additionally carry out a light curing if photopolymerization initiators are additionally added to the first and/or second adhesive component. Suitable photoinitiators induced by visible light are familiar to a person skilled in the art and comprise, for example, α-diketones, such as campherquinone, diaryliodonium salts and the like.

The dental restoration material is applied to the tooth substance, coated with the dental adhesive, preferably before the dental adhesive has completely cured. The dental restoration material is preferably applied to the tooth substance coated with the dental adhesive immediately after application of the dental adhesive. Suitable dental restoration materials are in particular self-curing synthetic filling materials, such as, for example, dental composites.

The invention has recognized that high bond values can surprisingly be achieved with a kit according to the invention even without the separate primer stage (between etching stage and application of the dental adhesive) considered necessary in the state of the art. The invention accordingly combines a simplified handling with at least equally good bond values as, generally even better bond values than, the state of the art (for example according to EP 0 767 652 B1).

In the context of the invention, it is particularly preferable for the first and/or second adhesive component to additionally exhibit a film-forming agent. The term film-forming agent describes any substance which can form, on the etched tooth substance, a film essentially completely covering the surface and which is curable, in particular polymerizable. The film-forming agent is preferably at least so well soluble in water that a solution of 5% by weight of this film-forming agent in water can be prepared. It is preferably completely miscible with water. Film-forming agents preferably comprise hydrophilic groups, such as, for example, hydroxyl groups, carboxyl groups, sulfonic acid groups or the like. The film-forming agent preferably comprises polymerizable groups, such as, e.g., vinyl groups, particularly preferably acrylate or methacrylate groups.

The film-forming agent can in terms of material be completely or in part identical to the polymerizerable monomer of the second adhesive component not comprising acid groups. In other words, a particular substance or a mixture of several substances can at the same time be a film-forming agent and a polymerizable monomer of the second adhesive component.

The preferred film-forming agents include 2-hydroxyethyl acrylate, 2-hydroxyethyl methacrylate (“HEMA”), 2- and 3-hydroxypropyl acrylate and methacrylate, 1,3- and 2,3-dihydroxypropyl acrylate and methacrylate, 2-hydroxypropanediyl 1,3-diacrylate and 1,3-dimethacrylate, 3-hydroxypropanediyl 1,2-diacrylate and 1,2-dimethacrylate, pentaerythritol diacrylate and dimethacrylate, acrylic acid, methacrylic acid, 2-trimethylammonioethylmethacryloyl chloride, 2-acrylamido-2-methylpropanesulfonic acid, acrylamide, methacrylamide, 2-hydroxyethylacrylamide, 2-hydroxyethylmethacrylamide, N,N-bis(2-hydroxyethyl)acrylamide, N,N-bis(2-hydroxyethyl)methacrylamide, N-alkyl-N-hydroxyethylacrylamide, N-alkyl-N-hydroxyethylmethacrylamide, 2- and 3-hydroxypropylacrylamide, 2- and 3-hydroxypropylmethacrylamide, methacrylamidopropyltrimethylammonium chloride, polyethylene glycol 400 diacrylate and dimethacrylate, and mixtures thereof.

Particularly preferred film-forming agents are: 2-hydroxymethyl methacrylate; 2- and 3-hydroxypropyl acrylate; 2- and 3-hydroxypropyl methacrylate; 1,3- and 2,3-dihydroxypropyl acrylate; and 1,3- and 2,3-dihydroxypropyl methacrylate.

The proportion of the film-forming agent to the total weight of the first and second adhesive components, when these are mixed in the designated mixing ratio, is preferably at least 30% by weight, more preferably at least 40% by weight, more preferably at least 50% by weight. Preferred upper limits are 70% by weight, particularly preferably 60% by weight. In the context of preferred embodiments of the invention, the upper limits mentioned can be combined with the lower limits mentioned in any way to give ranges.

In one embodiment of the invention, the first and second adhesive components of the kit are provided together in an applicator in which they are stored separately. The applicator exhibits devices for mixing the first and second adhesive components and for withdrawing the mixture. Suitable applicators are, for example, disclosed in WO 2007/017255 A2, which, through reference thereto, is made the subject matter of the disclosure of the present application.

The applicator can additionally provide the electron-donating compound, which is stored separately from the adhesive components and can be withdrawn separately. In this embodiment of the invention, the applicator accordingly combines all three components of the kit in a single applicator. Two of the components (the first and second adhesive components) can be mixed before withdrawal and the third component (the electron-donating compound) can be withdrawn and applied separately using the applicator.

In the context of the invention, the kit can additionally comprise an acid component for etching the tooth substance. It is accordingly on the one hand possible for the kit to be composed only of three components and, in the application, for the dentist to additionally fall back upon a normal acid for etching the tooth substance. In the context of the embodiments of the invention which are mentioned, the acid can however also be provided as fourth component of the kit according to the invention.

The dental restoration material, such as, for example, a dental composite, can also be provided as additional component of the kit. Alternatively, the user of the kit can fall back upon normal and commercially available dental restoration materials, in addition to the kit.

The kit can additionally comprise instructions for application. The instructions for application preferably mention the following stages:
a. etching of the tooth substance with an acid,
b. application of the electron-donating compound to the etched tooth substance,
c. mixing of the first and second adhesive components and application of the mixture to the tooth substance,
d. application of the dental restoration material to the tooth substance.

An additional subject matter of the invention is the use of the following components:
a. an electron-donating compound;
b. a first adhesive component which comprises an oxidizing agent as constituent of a polymerization initiator system and a polymerizable acid;
c. a second adhesive component which comprises a reducing agent as constituent of a polymerization initiator system and a polymerizer monomer, oligomer, or prepolymer not comprising acid groups;

in the preparation of a kit for fixing a dental restoration material on a tooth substance, the components of the kit being arranged for the application comprising the following stages:
etching of the tooth substance with an acid,
application of the electron-donating compound to the etched tooth substance,
mixing of the first and second adhesive components and application of the mixture to the tooth substance,
application of the dental restoration material to the tooth substance.

The advantages and preferred embodiments explained above in connection with the kit are correspondingly also valid for the use according to the invention mentioned here.

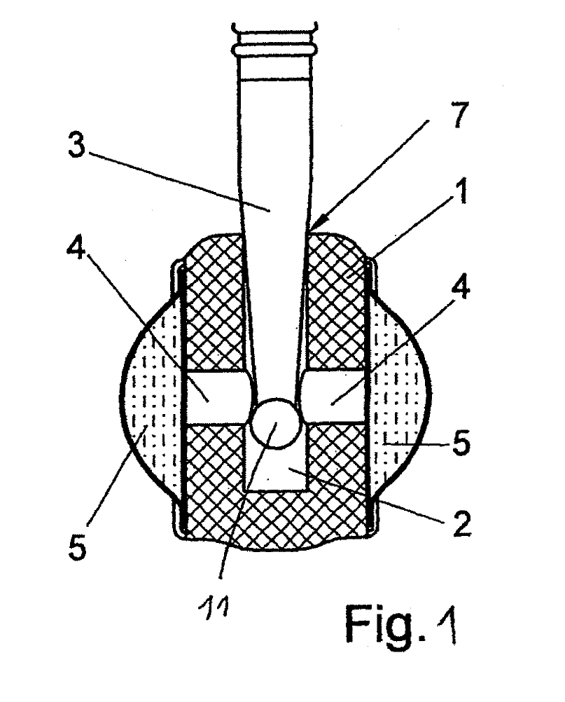

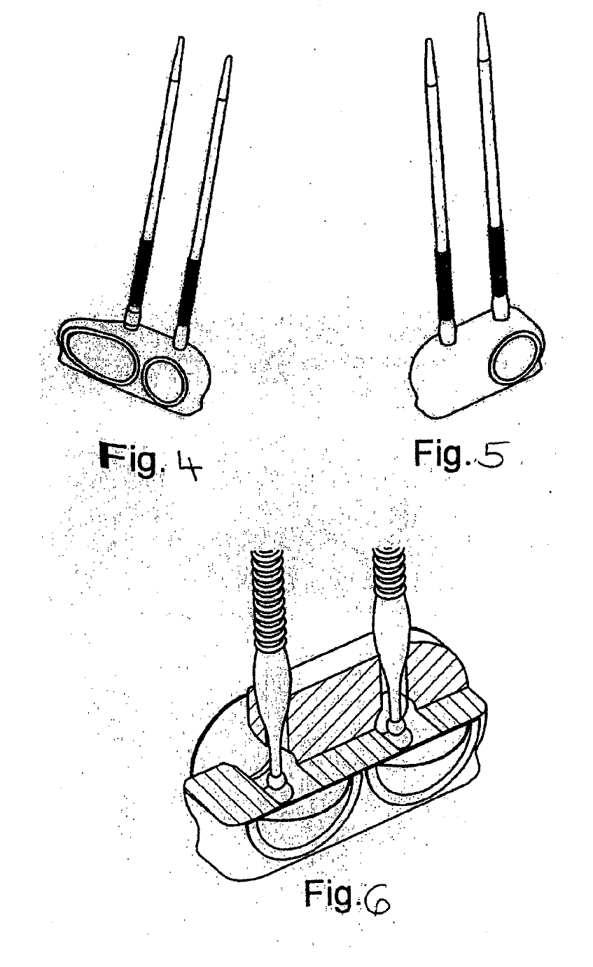

The invention is explained below using examples. In this connection, FIGS. 1 to 5 show embodiments of the invention in which the kit is provided in an applicator.

### COMPARATIVE EXAMPLE 1

The adhesive system used in this comparative example 1 corresponds to example 4 of EP 0 767 652 B1. Four components of the following composition were prepared.

| | % by weight |
|---|---|
| Activator | |
| Ethanol | 97 |
| Benzenesulfinic acid, sodium salt | 3 |
| | 100 |
| Primer | |
| Methacrylated polyacrylic acid | 13.3 |
| Water | 46.9 |
| HEMA—Hydroxyethyl methacrylate | 39.8 |
| | 100 |
| Peroxide resin (A1) | |
| HEMA—Hydroxyethyl methacrylate | 36.679 |
| Bis-GMA—Bisphenol A glyceryl dimethacrylate | 61.128 |
| BPO—Benzoyl peroxide | 2.1 |
| BHT—2,6-Di(tert-butyl)-4-methylphenol 1) | 0.093 |
| | 100 |
| Amine resin (B1) | |
| HEMA—Hydroxyethyl methacrylate | 37.080 |
| Bis-GMA—Bisphenol A glyceryl dimethacrylate | 61.780 |
| BHT—2,6-Di(tert-butyl)-4-methylphenol 1) | 0.01 |
| CQ—Camphorquinone | 0.25 |
| EDMAB—Ethyl dimethylaminobenzoate 2) | 0.5 |
| DHEPT—N,N-bis(2-hydroxyethyl)-p-toluidine | 0.38 |
| | 100 |

1) Stabilizing agent
2) Coinitiator for the photoinitiator camphorquinone

The bonding strength on bovine dentin with these components was measured according to ISO/TS 11405:2003.

In a first stage, the bovine dentin was etched for 15 s with 35% phosphoric acid and was subsequently rinsed with water.

Subsequently, the electron-donating solution (activator) was applied. In the next stage, the primer was applied. The two adhesive components A1 and B1 were mixed in the ratio by volume of 1:1 and were applied to the dentin treated with primer.

In the next stage, a self-curing synthetic filling material (Luxacore® from DMG, Dental-Material Gesellschaft mbH, 22547 Hamburg) was applied to this prepared surface and allowed to cure.

Subsequently, the SBS bond values were measured according to ISO/TS 11405:2003. The mean value of seven measurements was 5.1±1.4 MPa.

### EXAMPLE 1

In this example, the electron-donating compound (activator) and, as second adhesive component, the amine resin are adopted unchanged from comparative example 1. A 1:1 mixture of primer and peroxide resin from comparative example 1 is used as first adhesive component.

The procedure in the preparation of the test specimens and the measurement of the SBS bond values is as in comparative example 1, with the following changes:
the stage of the application of the primer is dispensed with,
a mixture of first adhesive component and second adhesive component (amine resin), mixed in the ratio by volume of 2:1, is immediately applied to the etched tooth substance.

Nine measurements of the SBS bond value are carried out; the mean value is 8.7±3.3 MPa.

### EXAMPLE 2

A kit with the following composition is provided:

| | % by weight |
|---|---|
| Activator | |
| Ethanol | 97 |
| Benzenesulfinic acid, sodium salt | 3 |
| | 100 |
| First adhesive component | |
| Aqueous methacrylated polyacrylic acid | 10 |
| GDM—Glyceryl dimethacrylate | 20 |
| HEMA—Hydroxyethyl methacrylate | 48.5 |
| Bis-GMA—Bisphenol A glyceryl dimethacrylate | 20 |
| BPO—benzoyl peroxide | 1.5 |
| BHT—2,6-Di(tert-butyl)-4-methylphenol | 0.1 |
| | 100 |
| Second adhesive component | |
| HEMA—Hydroxyethyl methacrylate | 50 |
| EPDMA—Ethoxylated bisphenol A dimethacrylate | 48.59 |
| BHT—2,6-Di(tert-butyl)-4-methylphenol | 0.01 |
| CQ—Camphorquinone | 0.5 |
| EDMAB—Ethyl dimethylaminobenzoate | 0.5 |
| DHEPT—N,N-bis(2-hydroxyethyl)-p-toluidine | 0.4 |
| | 100 |

The bonding strength on bovine dentin with these components was measured according to ISO/TS 11405:2003.

In a first stage, the bovine dentin was etched for 15 s with 35% phosphoric acid and was subsequently rinsed with water.

Subsequently, the electron-donating solution (activator) was applied. The two adhesive components were mixed in the ratio by volume of 1:1 and were applied to the etched dentin.

In the next stage, a self-curing synthetic filling material (Luxacore®, DMG) was applied to this preprepared surface and allowed to cure.

The SBS bond value as mean value of eight measurements was 10.6±4.4 MPa.

Examples 1 and 2 show that, in comparison with the state of the art (comparative example 1), a considerably improved adherence is achieved with simultaneously simplified handling.

FIGS. 1 to 6 show applicators in which a kit according to the invention can be provided. Such applicators taken per se are described in WO 2007/017225 A2.

FIG. 1 shows the basic concept of such an applicator. A receptacle 1 exhibits a cavity 2 into which an applicator hand instrument 3 can be inserted through a first opening 7. Openings 4 extend perpendicularly to the axis of the applicator hand instrument 3 and connect the cavity 2 to the outer wall of the receptacle 1. Sheet bags 5 are put on the corresponding openings in the outer wall of the receptacle 1. These are impermeable to liquids and gases and are used to store the first and second adhesive components.

In preparing to use, pressure is exerted externally on the sheet bags 5, so that these tear in the region of the openings 4 and the contents are squeezed into the cavity 2 and mixed there. The mixing can be assisted using the applicator hand instrument 3. After mixing, the mixture can be withdrawn using the applicator hand instrument 3. The tip 11 can in this connection have the form of a suitable instrument for applying the substance, for example a thin brush, sponge, spatula or cone.

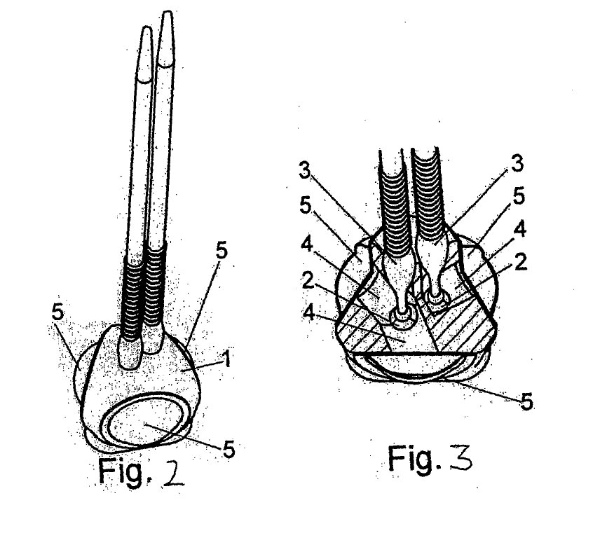

An applicator exhibiting two cavities 2 separated from one another with an applicator hand instrument 3 inserted into each is represented in FIGS. 2 and 3. The left-hand cavity 2 in FIGS. 2 and 3 is connected to two sheet bags 5 via two openings 4, so that the first and second adhesive components can be mixed therein. The right-hand cavity in the figure is provided with only one opening 4 and one sheet bag 5; this concerns the electron-donating compound.

In the application, the right-hand sheet bag 5 can first be squeezed out and the contents thereof forced into the right-hand receptacle 2. The electron donating compound can then be withdrawn using the right-hand applicator hand instrument 3.

In the next stage, the two left-hand sheet bags with the first and second adhesive components can be squeezed out and these two components mixed in the left-hand cavity 2. Subsequently, they can be withdrawn using the left-hand applicator hand instrument 3 and applied to the tooth substance.

FIGS. 4 to 6 show an additional embodiment of an applicator according to the invention. The left-hand cavity in FIG. 4 is provided with two openings and corresponding sheet bags, the contents of which can be mixed in the accompanying cavity 2. These two sheet bags comprise the first and second adhesive components. The right-hand cavity in FIG. 4 is connected to only one sheet bag, which comprises the electron-donating compound.

1. A kit for fixing a dental restoration material onto a tooth substance, characterized by the following components:
a. an electron-donating compound;
b. a first adhesive component which comprises an oxidizing agent as constituent of a polymerization initiator system and a polymerizable acid; and
c. a second adhesive component which comprises a reducing agent as constituent of a polymerization initiator system and a polymerizable monomer, oligomer or prepolymer not comprising acid groups.

2. The kit as claimed in claim 1, wherein the electron-donating compound is present in a physiologically acceptable solvent.

3. The kit as claimed in claim 2, wherein the physiologically acceptable solvent is readily volatile at body temperature.

4. The kit as claimed in claim 3, wherein the physiologically acceptable solvent is an alcohol.

5. The kit as claimed in claim 1, wherein the reducing agent comprises an amine.

6. The kit as claimed in claim 5, wherein the amine is a tertiary aromatic amine.

7. The kit as claimed in claim 1, wherein the polymerizable acid comprises polymerizable homo- and/or copolymers of an α,β-unsaturated carboxylic acid.

8. The kit as claimed in claim 1, wherein the polymerizable acid exhibits a mean molar mass of 2000 to 100 000.

9. The kit as claimed in claim 1, wherein the oxidizing agent is an organic peroxide.

10. The kit as claimed in claim 1, wherein the polymerizable monomer not comprising an acid group includes a monomer comprising a vinyl group.

11. The kit as claimed in claim 1, wherein the first and/or second adhesive component additionally exhibit(s) a film-forming agent.

12. The kit as claimed in claim 11, wherein the film-forming agent is chosen from the group consisting of 2-hydroxymethyl methacrylate; 2- and 3-hydroxypropyl acrylate; 2- and 3-hydroxypropyl methacrylate; 1,3- and 2,3-dihydroxypropyl acrylate; and 1,3- and 2,3-dihydroxypropyl methacrylate.

13. The kit as claimed in claim 11, wherein the proportion of the film-forming agent to the total weight of the first and second adhesive components is at least 30% by weight and not more than 70% by weight.

14. The kit as claimed in claim 1, wherein the first and second adhesive components are provided together in an applicator in which they are stored separately and which exhibits devices for mixing the first and second adhesive components and for withdrawing the mixture.

15. The kit as claimed in claim 14, wherein the applicator additionally provides the electron-donating compound, which is stored separately from the adhesive components and can be withdrawn separately.

16. The kit as claimed in claim 1, wherein said kit additionally comprises an acid component for etching the tooth substance.

17. The kit as claimed in claim 1, wherein said kit additionally comprises a dental restoration material.

18. The kit as claimed in claim 1, wherein said kit additionally comprises instructions for application.

19. The kit as claimed in claim 14, wherein the instructions for application comprise the following stages:
a. etching of the tooth substance with an acid,
b. application of the electron-donating compound to the etched tooth substance,
c. mixing of the first and second adhesive components and application of the mixture to the tooth substance, and
d. application of the dental restoration material to the tooth substance.

20. The use of the following components:
a. an electron-donating compound;
b. a first adhesive component which comprises an oxidizing agent as constituent of a polymerization initiator system and a polymerizable acid; and
c. a second adhesive component which comprises a reducing agent as constituent of a polymerization initiator system and a polymerizer monomer, oligomer, or prepolymer not comprising acid groups;
in the preparation of a kit for fixing a dental restoration material on a tooth substance, the components of the kit being arranged for the application comprising the following stages:
i. etching of the tooth substance with an acid,
ii. application of the electron-donating compound to the etched tooth substance,
iii. mixing of the first and second adhesive components and application of the mixture to the tooth substance, and
iv. application of the dental restoration material to the tooth substance.

21. The kit as claimed in claim 3, wherein said alcohol is ethanol.

22. The kit as claimed in 8, wherein the polymerizable acid exhibits a mean molar mass of 20 000 to 40 000.

23. The kit as claimed in claim 10, wherein the polymerizable monomer not comprising an acid group includes a monomer comprising an acrylate or methacrylate.

24. The kit as claimed in claim 13, wherein the proportion of the film-forming agent to the total weight of the first and second adhesive components is at least 40% by weight and not more than 60% by weight.

25. The kit as claimed in claim 13, wherein the proportion of the film-forming agent to the total weight of the first and second adhesive components is at least 50% by weight and not more than 60% by weight.
